(19) United States
(12) Patent Application Publication
(10) Pub. No.: US 2006/0104694 A1
(43) Pub. Date: May 18, 2006

(54) Modular printer

(76) Inventor: Denis Montagutelli, Angers (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/531,878

(22) PCT Filed: Oct. 7, 2003
(86) PCT No.: PCT/FR03/02933

§ 371 Date: Oct. 31, 2005

(30) Foreign Application Priority Data
Oct. 19, 2002 (FR) 0213289

(51) Int. Cl. B41J 2/315

(52) U.S. Cl. 400/120.16

(57) ABSTRACT

The invention relates to a thermal printer composed of a plurality of modules assembled together to provide a range of distinct printers. Said printer comprises:
a) a first module (1) formed of a printing mechanism (4) fitted with a flexible connector (8) for associating the printing mechanism (4) with electronic control means (11, 12, 12′),
b) a second module (2) formed of a carrying member (9,10), which supports driving means (30, 31) of the printer and the electronic control means (11, 12, 12′) fitted with means (19, 35, 36) for association with a source of electric energy (20, 21), remote control means (6), and the driving means (30, 31),
c) a third module (3) formed of a carrying member (17), fitted with means for nesting the chassis (5) partaking of the first module (1) and of the carrying member (9,10) partaking of the second module (2).

The invention relates to thermal printers. It relates to a printer composed of a plurality of modules whereof the assembly between themselves enables to provide a range of distinct printers.

It should be reminded that a thermal printer comprises mainly a magazine of a band to be printed, conditioned into a roll, associated with means necessary to conveying the band and to print it by heating points.

The economic constraints in the art tend to impose to the designers an organisation of the printer which confers a modular character thereto, to enable from a plurality of interchangeable modules, to provide a range of various printers. Such an approach has been tackled by the document WO01/25020 (AXIOHM TRANSACTION SOLUTIONS) for instance.

The problem which the present invention intends to solve, lies in the optimisation of the usage, in all or in part, of the members partaking of the printer.

Within this framework, a difficulty to overcome lies the adaptability of these different members of elaborating, by modularity, different configurations of printers. This problem is even more difficult to solve since it should take into account the specific expectations of the users. More particularly, these expectations may correspond not only to specific needs for a given functionality of the printer, but also to requirements related to certain functionalities, in all or in part, of the printer.

It appears finally that the problem which the present invention intends to solve, beyond the answers to be brought to the requirements aforementioned of the users, lies a compromise to be found between the technical constraints relating to the structure and to the functionality of the different members forming the printer, and the potentialities related to their isolation, their to the judicious grouping into distinct modules, and to their association between themselves.

The purpose of the present invention is to provide a thermal modular printer whereof its structure enables to solve the problems aforementioned.

The printer of the present invention is a thermal printer composed globally of a plurality of modules assembled together in an easily reversible manner to enable, from a combination of modules, to provide a range of distinct printers. Said printer combines:

a) a thermal printing head of a band conditioned into a roll, slaved to electronic means for controlling the operation thereof. These electronic control means are fitted with associating means respectively with a source of electric energy, with general printing control means and with the thermal printing head.

b) means for conveying the band, from a magazine holding the roll, against the thermal printing head. Said conveying means comprise motorised means for driving 7 the band, a resilient back-up roll 24 of the band against the printing head, and a cutter 23 for the separation of a portion of printed band.

c) a first member carrying the band roll, in which member is provided the magazine 25 rotatably housing the roll.

d) a second member carrying electronic control means, fitted with nesting means easily reversible with the first carrying member.

From such a structure of printer, the present invention will be described in relation with the figures of the appended sheets which illustrate a preferred embodiment thereof, in which sheets:

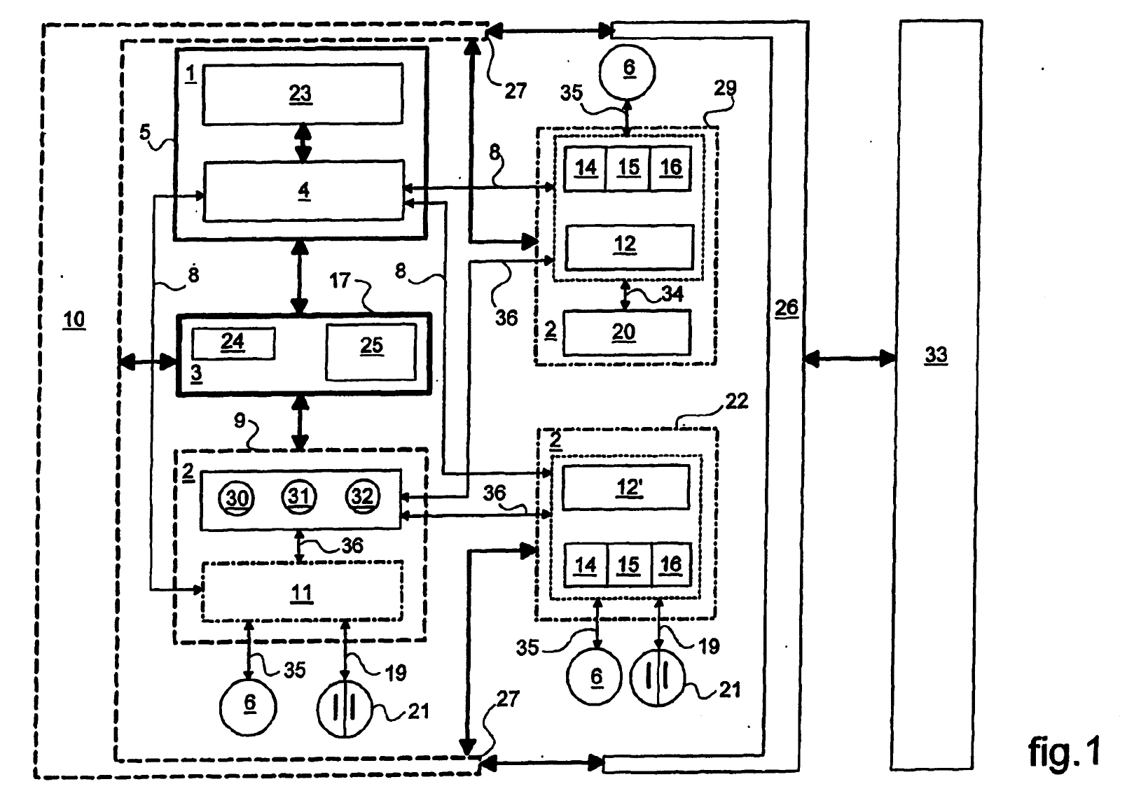

FIG. 1 is a schematic view illustrating a preferred structure of a printer relevant of the present invention.

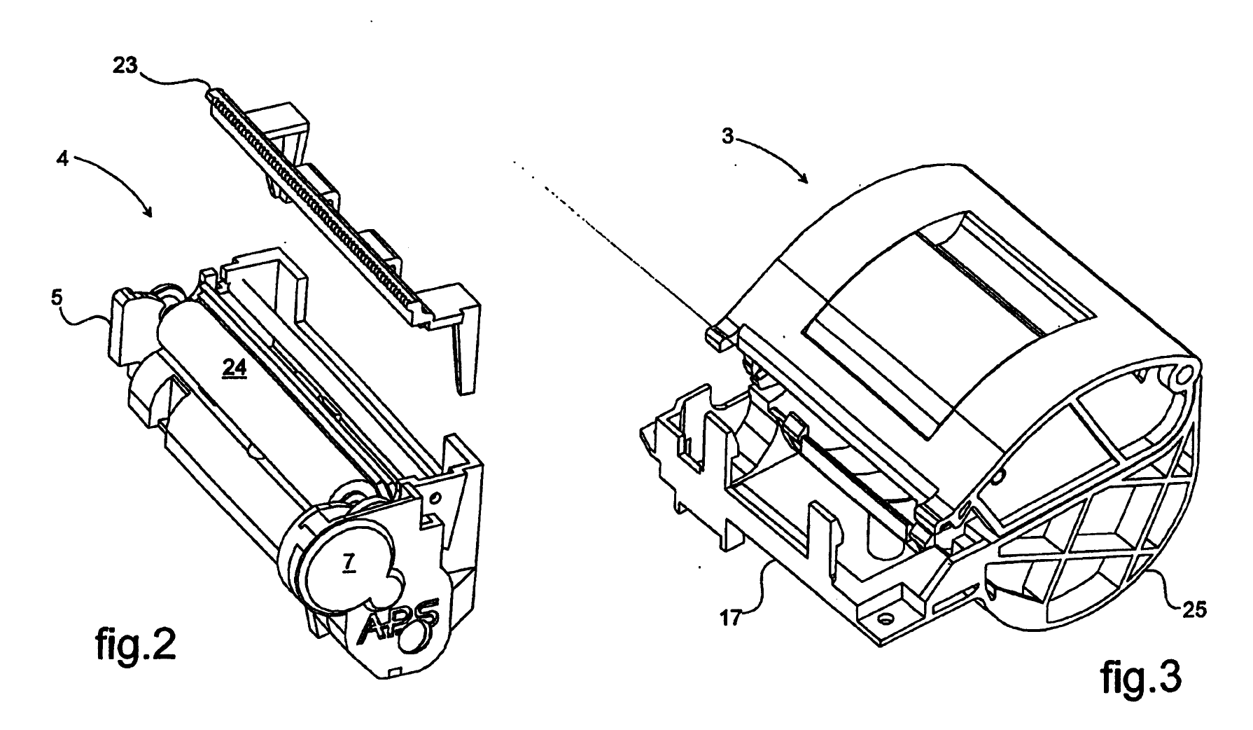

La FIG. 2 is a perspective exploded view of a first module of the printer schematised on FIG. 1

FIG. 3 is a perspective exploded view of a third module of the printer schematised on FIG. 1.

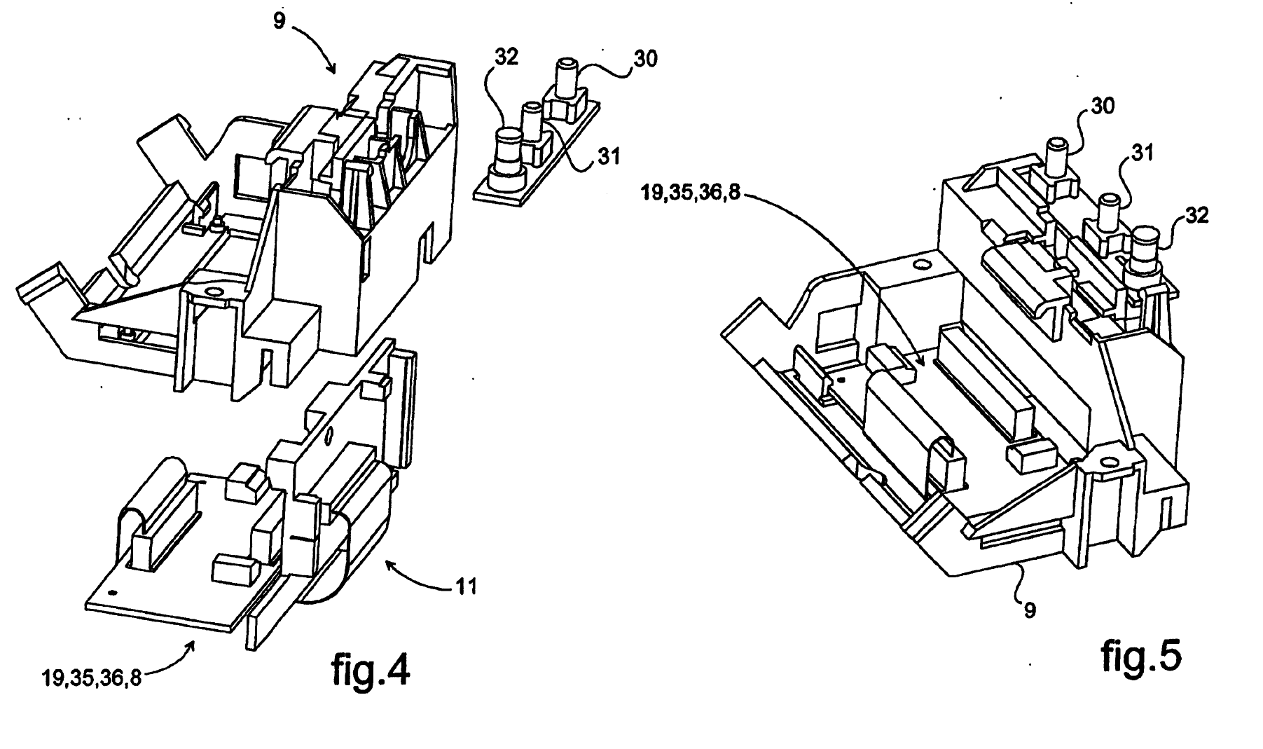

FIG. 4 and FIG. 5 are perspective views of a second module of the printer schematised on FIG. 1, according to a first configuration of the latter, respectively as an exploded view and as an assembled view.

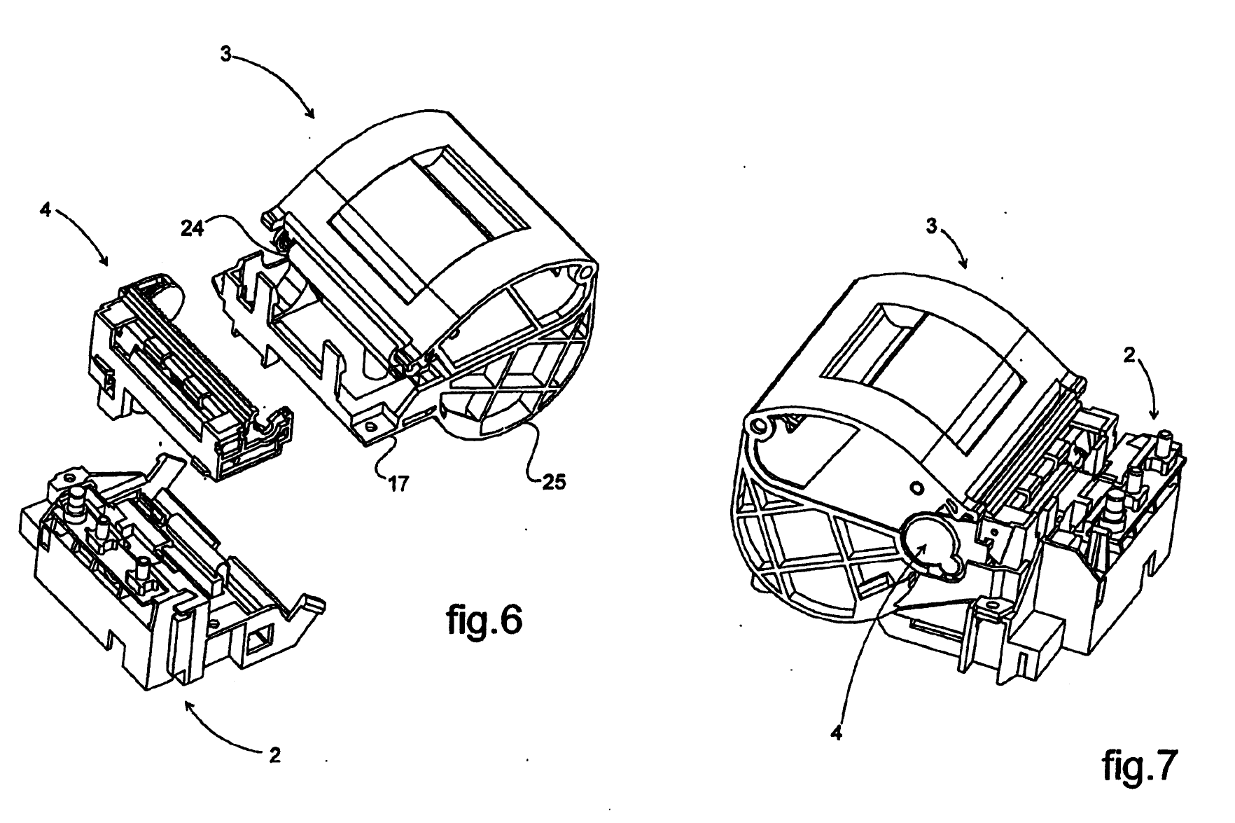

FIG. 6 and FIG. 7 are perspective views of a basic printer partaking of a printer schematised on FIG. 1, according to a configuration of the second module represented on FIG. 4 and FIG. 5, respectively as an exploded view and as an assembled view.

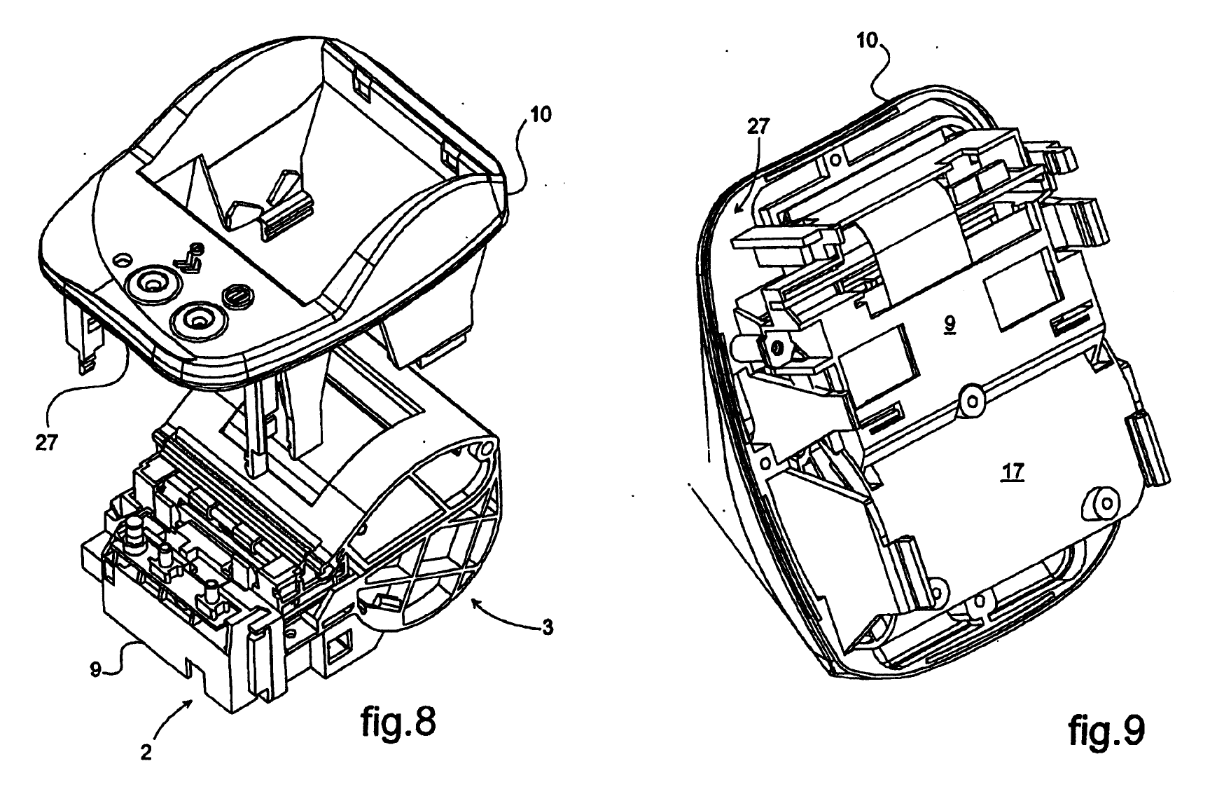

FIG. 8 and FIG. 9 are perspective views of a panel printer partaking of a printer schematised on FIG. 1, according to a second configuration of the latter, respectively as an exploded top view and as an assembled view from beneath.

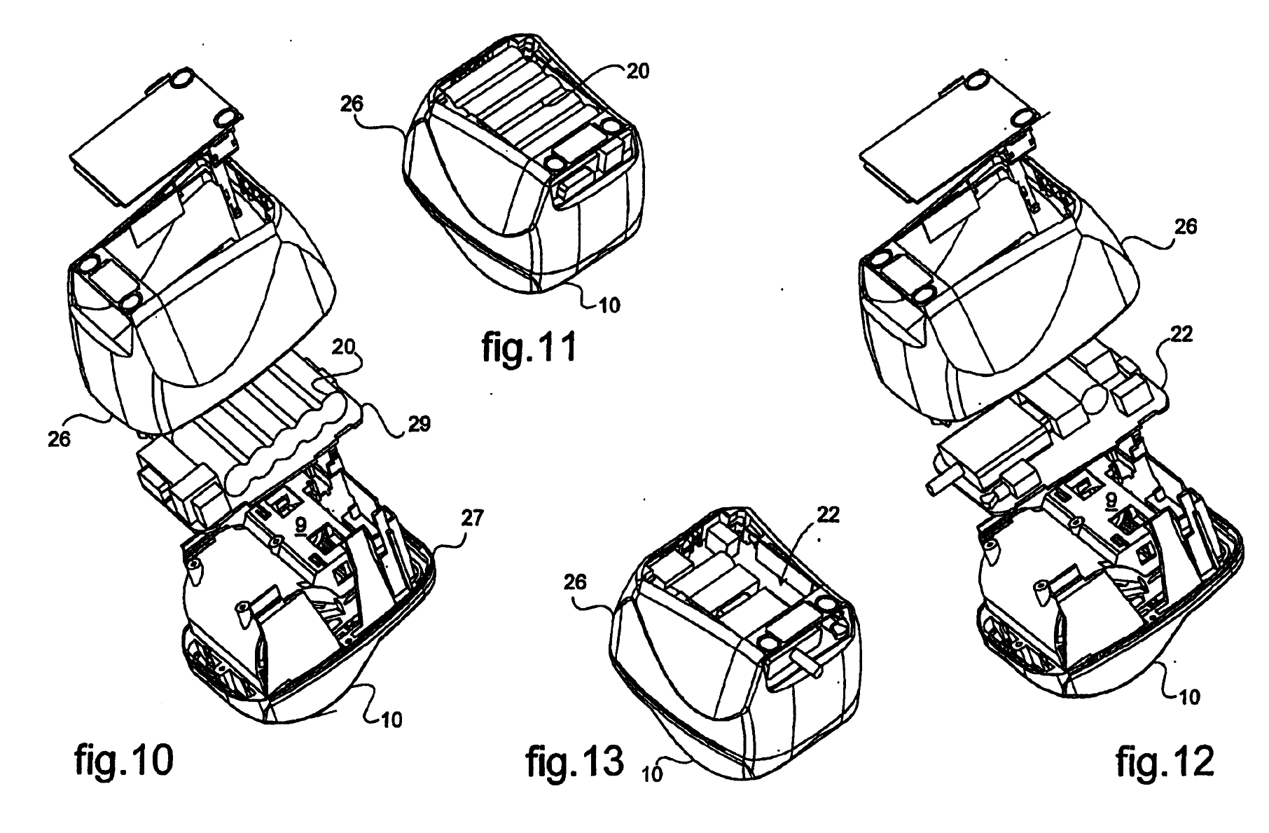

FIG. 10 and FIG. 11 are perspective views of a portable printer partaking of a printer schematised on FIG. 1, according to a third configuration of the latter, respectively as an exploded view and as an assembled view from beneath.

FIG. 12 and FIG. 13 are perspective views of an office printer partaking of a printer schematised on FIG. 1, according to a fourth configuration of the latter, respectively as an exploded view and as a top assembled view.

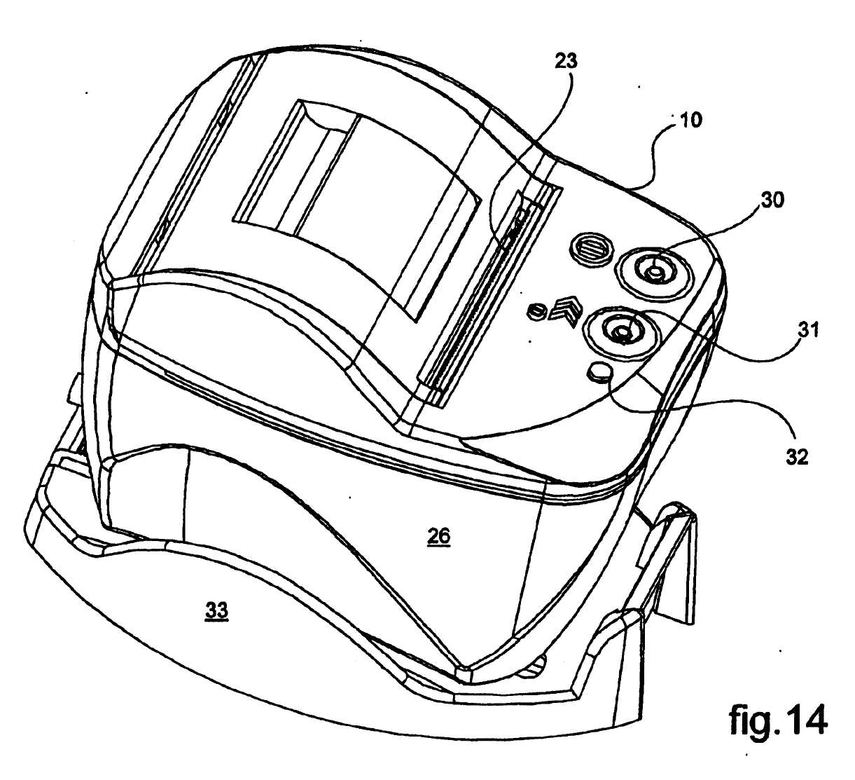

FIG. 14 is a perspective view of an office printer represented on FIG. 12 and FIG. 13, fitted with a base.

On FIG. 1, a printer of the invention is mainly recognisable in that it comprises:

a) A first module 1 formed mainly of a printing mechanism 4, which comprises a chassis 5 carrying the printing head, of motorised means 7 for driving the band, and of a flexible connector 8 for associating the printing mechanism 4 with electronic control means 11, 12, 12′. Said first module is more particularly represented on FIG. 2. It should be noted at this stage of the description that the printing mechanism 4 carries advantageously a cutter 23 for separating a portion of printed band.

b) a second module 2, mainly composed of a second carrying member 9,10. It should be noted at this stage of the description that this carrying member is preferably formed of two supports 9 and 10, according to the configurations of printers obtained thanks to the arrangement of the members forming the printer of the invention illustrated. Said second module 2 supports first of all driving means 30, 31 for operating the printer by the user. These driving means 30, 31 which partake of the general printing control means of the printer, comprise for instance push-buttons associated with a LED 32 for visualising the operation of the printer. Said second module 2 supports moreover electronic control means 11, 12, 12′, as well as means 19, 34, 35, 36 wherewith they are fitted for association with a source of electric energy 20,21, with remote control means 6 partaking of the general printing control means, and with the driving means 30, 31.

c) a third module 3 mainly composed of a first carrying member 17, which is fitted with easily reversible general nesting means on the one hand of the chassis 5 partaking of the first module 1, and on the other hand of the second carrying member 9,10 partaking of the second module 2.

According to a first configuration of the printer of the invention, and while also referring more particularly to FIG. 4, FIG. 5, FIG. 6 and FIG. 7, the second carrying member comprises a first support 9 fitted with means co-operating with easily reversible first elementary nesting means installed on the first carrying member 17. Said first support 9 carries driving means 30, 31, as well as first electronic control means 11 and related associating means 19, 35, 36.

According to a second configuration of the printer of the invention, and while referring not only to FIG. 1, but also to FIG. 8 and FIG. 9, the second carrying member includes, not only the first support 9, but also a second support 10 arranged as a dummy cover, capping notably the third module 3 carrying the printing mechanism 4, and the first support 9 of the second module 2.

It should be noted at this stage of the description that this dummy cover 10 includes advantageously a peripheral shoulder 27 in its middle zone of its thickness, for notably a configuration of the printer of the invention as a panel printer, or for the reception of a rear closing shell 26, against which the cover 10 rests flatly, according to alternative configurations, via its peripheral shoulder 27.

According to a third and a fourth configurations of the printer of the invention, and while referring not only to FIG. 1, but also to FIG. 10 and FIG. 11 on the one hand and to FIG. 12 and FIG. 13 on the other hand, the second support advantageously formed of the dummy cover 10 carries second electronic control means 12, 12′ and related associating means 19, 34, 35, 36. It will be understood that these means 12, 12′ and 19, 34, 35, 36 are substitutive of the electronic control means 11 and related associating means 19, 34, 35, 36 supported by the first support 9. Said second support 10 is fitted with means co-operating with easily reversible second elementary nesting means fitting the first carrying member 17. Said second electronic control means 12, 12′ and the related associating means 19, 34, 35, 36 comprise means analogous to the first electronic control means 11 and to the first related associating means, in view of said substitution, complemented by related means comprising any at least of management means 14 specific to the source of electric energy 20, 21, of specific electronic control means 15 partaking of the general printing control means and of means for storing information 16 a transmitted remotely by the remote printing control means 6.

More particularly and according to alternatives between the third and fourth configurations, the second electronic control means comprise elementary electronic control means 12, 12′ alternative by substitution, which are supported by the second support 10

First elementary means 12 of said second electronic control means are fitted with associating means 34 with a stand-alone source 20 of electric energy, while second elementary means 12′ of these second control means are fitted with associating means 19 with the electric energy supply mains 21.

It will be noted on the example illustrated, that the second support, which is mainly composed of the dummy cover 10, provides easily reversible nesting on the first carrying member 17. It will be noted also that an electronic board 22, 29 carrying the second electronic control means 12, 12′ complemented by the related means 14, 15, 16 is preferably added also by easily reversible nesting at the rear face of the cover 10, and at the rear of the first carrying member 17.

According to the third configuration illustrated on FIG. 10 and FIG. 11 of the printer of the invention, the stand-alone source of electric energy 20 comprises at least one battery carried by the rear face of the electronic board 29. The latter 29 moreover carries first elementary means 12 of the second electronic control means and relate associating means 34, 35, 36. Said battery 20 is advantageously housed in a space provided between the shell 26 and the electronic board 29, the latter 29 forming a separation wall for mechanic and electrostatic protection of the printing mechanisms 4 and of the control means 12. It will be noted that the shell 26 is preferably fitted at its rear face with easily reversible nesting means with a base 33, such as a wall or table base illustrated on FIG. 14.

While referring to the driving means, the former comprise for instance at least one pusher 30 for implementing of the motorised means 7 for driving the band, and at least one pusher 31 for implementing the printing mechanism 4, related to a means for visualising 32 the operating state of the printer

It will be noted also that the cutter 23 is preferably mounted in an easily reversible manner on the chassis 5 of the first module 1, and that a back-up roll 24 of the band against the printing head of the printing mechanism 4 is preferably mounted on the first carrying member 17 of the third module 3.

While referring to FIG. 6 and FIG. 7, there will be noted therefore a configuration of a printer of the invention as a basic printer, said basic printer comprising:

a) a first module 1 formed mainly of a printing mechanism 4 comprising a chassis 5 carrying a printing head, of motorised means 7 for driving the band, of a flexible connector 8 for associating the printing mechanism 4 with remote electronic control means 11, and of a cutter 23 for separating a portion of printed band,

b) a second module 2 mainly composed of a second carrying member 9, which supports in an easily reversible manner on the one hand means 30, 31 for driving the operation of the printer, and on the other hand the electronic control means 11 fitted with associating means 35, 19, 36 with remote electronic control means 6, with a remote source of electric energy 21, and with the driving means 30, 31,

c) a third module mainly composed of a first carrying member 17 supporting in an easily reversible manner on the one hand the chassis 5 partaking of the first module 1 and a back-up roll 24 of the band against the printing head, and on the other hand the second carrying member 9 partaking of the second module 2.

While referring to FIG. 8 and FIG. 9, there will be noted therefore a configuration of a printer of the invention as a panel printer, said panel printer comprising:

a) a first module 1 formed mainly of a printing mechanism 4 comprising a chassis 5 carrying a printing head, of motorised means 7 for driving the band, of a flexible connector 8 for associating the printing mechanism 4 with remote electronic control means 11, and of a cutter 23 for separating a portion of printed band,

b) a second module 2 mainly composed of a second carrying member 9, which supports in an easily reversible manner on the one hand means 30, 31 for driving the operation of the printer by the operator and on the other hand the electronic control means 11 fitted with associating means 35, 19, 36 with remote electronic control means 6, with a remote source of electric energy 21, and with the driving means 30, 31,

c) a third module 3 mainly composed of a first carrying member 17 supporting in an easily reversible manner on the one hand the chassis 5 partaking of the first module 1 and a back-up roll 24 of the band against the printing head, and on the other hand the second carrying member 9 partaking of the second module 2,

d) a dummy cover 10 with easily reversible nesting on the first carrying member 17, which includes in the middle zone of its thickness a peripheral shoulder 27 bearing flat against a panel.

It will be noted that according to another configuration of a printer of the invention to a panel printer, not represented on the figures, said printer comprises:

a) a first module 1 formed mainly of a printing mechanism 4 comprising a chassis 5 carrying a printing head, of motorised means 7 for driving the band, of a flexible connector 8 for associating the printing mechanism 4 with remote electronic control means 12, 12′, and of a cutter 23 for separating a portion of printed band,

b) a second module 2 mainly composed of a second carrying member 9, which supports in an easily reversible manner on the one hand means 30, 31 for driving the operation of the printer by the operator and on the other hand electronic control means 12, 12′ fitted with associating means 35, 34, 19, 36 with remote electronic printing control means 6, with a source of electric energy 20, 21, and with the driving means 30, 31, said electronic control means 12, 12′ being complemented by any at least of management means 14 specific to the source of electric energy, of integrated electronic control means 15 and of means for storing information 16 transmitted remotely by the remote printing control means 6,

c) a third module 3 mainly composed of a first carrying member 17 supporting in an easily reversible manner on the one hand the chassis 5 partaking of the first module 1 and a back-up roll 24 of the band against the printing head, and on the other hand the second carrying member 9 partaking of the second module 2,

d) a dummy cover 10 with easily reversible nesting on the first carrying member 17, which includes in the middle zone of its thickness a peripheral shoulder 27 bearing flat against a panel.

While referring to FIG. 10 and FIG. 11, there will be noted therefore a configuration of a printer of the invention as a portable printer, said portable printer comprising:

a) a first module 1 formed mainly of a printing mechanism 4 comprising a chassis 5 carrying a printing head, of motorised means 7 for driving the band, of a flexible connector 8 for associating the printing mechanism 4 with the remote electronic control means 12, and of a cutter 23 for separating a portion of printed band,

b) a second module 2 mainly composed of a second carrying member formed of a first support 9 and of a second support 10, the first support 9 carrying driving means 30, 31 for operating the printer by the user, the second support 10 being arranged as a dummy cover and supporting in an easily reversible manner on the one hand a battery 20 forming the source of electric energy, and on the other hand the electronic control means 12 filted with associating means 35, 34, 36 with remote electronic control means 6, with a source of electric energy 20, and with the driving means 30, 31, said electronic control means 12 being complemented by any at least of management means specific 14 of the source of electric energy 20, of integrated electronic control means 15 and of means for storing information 16 transmitted remotely by the remote printing control means 6,

c) a third module 3 mainly composed of a first carrying member 17 supporting in an easily reversible manner on the one hand the chassis 5 partaking of the first module 1 and a back-up roll 24 of the band against the printing head, and on the other hand the first support 9 and the second support 10 forming the second carrying member,

d) a rear closing shell 26 which can be added in a highly reversible fashion on the second support 10, said shell 26 providing a space for accommodating the battery 20 between the rear face of the printer and a board 29 carrying electronic means 12, 14, 15, 16 of the second module 2 and of the battery 20, said board 29 forming a separation wall with mechanical and electrostatical insulation.

While referring to FIG. 12 and FIG. 13, there will be noted therefore a configuration of a printer of the invention as an office printer, said office printer comprising

a) a first module 1 formed mainly of a printing mechanism 4 comprising a chassis 5 carrying a printing head, of motorised means 7 for driving the band, of a flexible connector 8 for associating the printing mechanism 4 with the remote electronic control means 12′, and of a cutter 23 for separating a portion of printed band,

b) a second module 2 mainly composed of a second carrying member formed of a first support 9 and of a second support 10, the first support 9 carrying driving means 30, 31 for operating the printer by the user, the second support 10 being arranged as a dummy cover and supporting in an easily reversible manner the electronic control means 12′ fitted with associating means 35, 19, 36 with remote electronic printing control means 6, with a source of electric energy 21, and with the driving means 30, 31, said electronic control means 12′ being complemented by any at least of management means specific 14 of the source of electric energy 21, of integrated electronic control means 15 and of means for storing information 16 transmitted remotely by the remote printing control means 6, the source of electric energy 21 being a remote source,

c) a third module 3 mainly composed of a first carrying member 17 supporting in an implicit reversible manner on the one hand the chassis 5 partaking of the first module 1 and a back-up roll 24 of the band against the printing head, and on the other hand the first support 9 and the second support 10 forming the second carrying member,

d) a rear closing shell 26 which can be added in an easily reversible manner on the second support 10.

1. A thermal printer composed globally of a plurality of modules assembled together in an implicit reversible manner to enable, from a combination of modules, to provide a range of distinct printers, said printer associating:
a) a thermal printing head of a band conditioned into a roll, slaved to electronic means for controlling the operation thereof, which are fitted with associating means respectively with a source of electric energy, with general printing control means and with the thermal printing head,
b) means for conveying the band from a magazine holding the roll against the thermal printing head, said conveying means comprising motorised means for driving the band, a resilient back-up roll of the band against the printing head, and a cutter for the separation of a portion of printed band,
c) a first member carrying the band roll, in which member is provided the magazine rotatably housing the roll,
d) a second member carrying electronic control means, fitted with nesting means easily reversible with the first carrying member,
wherein the thermal printer comprises:
a) a first module formed mainly of a printing mechanism comprising a chassis carrying the printing head, motorised means for driving the band, and of a flexible connector for associating the printing mechanism with the electronic control means,
b) a second module mainly composed of the second carrying member, which supports on the one hand means for controlling the operation of the printer by the operator partaking of the general printing control means, and on the other hand the electronic control means as well as the means wherewith they are fitted for association with the source of electric energy, with remote control means partaking of the general printing control means, and with the driving means,
c) a third module mainly composed of the first carrying member, the latter being provided with general nesting means easily reversible on the one hand of the chassis partaking of the first module and on the other hand of the second carrying member partaking of the second module.

2. A printer according to claim 1,
in that wherein the second carrying member comprises a first support fitted with means co-operating with easily reversible first elementary nesting means installed on the first carrying member, said first support carrying the driving means as well as first electronic control means and related associating means.

3. A printer according to claim 2,
wherein the second carrying member comprises moreover a second support carrying second electronic control means and related associating means, substitutive of electronic control means and related associating means, said second support being fitted with means co-operating with easily reversible second elementary nesting means installed on the first carrying member, said second electronic control means and the related associating means comprising means analogous to the first electronic control means and to the first related associating means, complemented by any at least management means specific to the source of electric energy, of specific electronic control means partaking of the general printing control means and of means for storing information transmitted remotely by the remote printing control means.

4. A printer according to claim 3,
wherein the second electronic control means comprise substitution alternative elementary electronic control means, which are supported by the second support, first elementary means of said second electronic control means being fitted with associating means with a stand-alone source of electric energy (, while second elementary means of these second control means are fitted with associating means with the electric energy supply mains.

5. A printer according to claim 3,
wherein the second support is mainly composed of a nesting dummy cover easily reversible on the first carrying member, at the rear face of which cover and at the rear of the first carrying member, is added by easily reversible nesting an electronic board carrying the second electronic control means complemented by the related means.

6. A printer according to claim 5,
wherein the cover includes in the middle zone of its thickness a peripheral shoulder bearing flat against a panel.

7. A printer according to claim 6,
which includes a rear closing shell against which rests the cover via its peripheral shoulder.

8. A printer according to
claim 4, wherein the stand-alone source of electric energy comprises at least one battery carried by the rear face of the electronic board which moreover carries first elementary means of the second electronic control means and of the related associating means, said battery being housed in a space provided between the shell and the electronic board, the latter forming a separation wall for mechanic and electrostatic protection of the printing mechanisms and of the control means.

9. A printer according to
claim 7, wherein the shell (is fitted at its rear face with easily reversible nesting means with a base.

10. A printer according to any of the previous claims, characterised:
claim 1, wherein the driving means comprise at least one pusher for implementing the motorised means for driving the band, and at least one pusher for implementing the printing mechanism, related to a means for visualising the operating state of the printer.

11. A printer according to
claim 1, wherein the cutter is mounted in an easily reversible manner on the chassis of the first module.

12. A printer according to
claim 1, wherein the back-up roll is mounted on the first carrying member of the third module.

13. An application of a printer according to claim 1 to a basic printer,
wherein the basic printer comprises
a) a first module formed mainly of a printing mechanism comprising a chassis carrying a printing head, motorised means for driving the band, of a flexible connector for associating the printing mechanism with remote electronic control means, and of a cutter for separating a portion of printed band,
b) a second module mainly composed of a second carrying member, which supports in an easily reversible manner on the one hand means for controlling the operation of the printer, and on the other hand the electronic control means fitted with associating means with remote electronic control means, with a remote source of electric energy, and with the driving means,
c) a third module mainly composed of a first carrying member supporting in an easily reversible manner on the one hand the chassis partaking of the first module and a back-up roll of the band against the printing head, and on the other hand the second carrying member partaking of the second module.

14. An application of a printer according to claim 1 to a panel printer,
wherein the panel printer comprises:
a) a first module formed mainly of a printing mechanism comprising a chassis carrying a printing head, motorised means for driving the band, of a flexible connector for associating the printing mechanism with remote electronic control means, and of a cutter for separating a portion of printed band.
b) a second module mainly composed of a second carrying member, which supports in an easily reversible manner on the one hand means for controlling the operation of the printer by the operator and on the other hand the electronic control means fitted with associating means with remote electronic control means, with a remote source of electric energy and with the driving means,
c) a third module mainly composed of a first carrying member supporting in an easily reversible manner on the one hand the chassis M partaking of the first module and a back-up roll of the band against the printing head, and on the other hand the second carrying member partaking of the second module,
d) a nesting dummy cover easily reversible on the first carrying member, which includes in the middle zone of its thickness a peripheral shoulder bearing flat against a panel.

15. An application of a printer according to claim 1 to a panel printer,
wherein the panel printer comprises:
a) a first module formed mainly of a printing mechanism comprising a chassis carrying a printing head, motorised means for driving the band, of a flexible connector for associating the printing mechanism with remote electronic control means, and of a cutter for separating a portion of printed band,
b) a second module mainly composed of a second carrying member, which supports in an easily reversible manner on the one hand means for controlling the operation of the printer by the operator and on the other hand the electronic control means fitted with associating means with remote electronic printing control means, with a source of electric energy, and with the driving means, said electronic control means being complemented by any at least management means specific to the source of electric energy, integrated electronic control means and means for storing information transmitted remotely by the remote printing control means,
c) a third module mainly composed of a first carrying member supporting in an easily reversible manner on the one hand the chassis partaking of the first module and a back-up roll of the band against the printing head, and on the other hand the second carrying member partaking of the second module,
d) a nesting dummy cover easily reversible on the first carrying member, which includes in the middle zone of its thickness a peripheral shoulder bearing flat against a panel.

16. An application of a printer according to claim 1 to a portable printer,
wherein the portable printer comprises:
a) a first module formed mainly of a printing mechanism comprising a chassis carrying a printing head, motorised means for driving the band, of a flexible connector for associating the printing mechanism with the remote electronic control means, and of a cutter for separating a portion of printed band,
b) a second module mainly composed of a second carrying member formed of a first support and of a second support, the first support carrying driving means for operating the printer by the user, the second support being arranged as a dummy cover and supporting in an easily reversible manner on the one hand a battery providing a source of electric energy, and on the other hand the electronic control means fitted with means for association with remote electronic control means, with a source of electric energy, and with the driving means, said electronic control means being complemented by any at least management means specific of the source of electric energy, integrated electronic control means and means for storing information transmitted remotely by the remote printing control means,
c) a third module mainly composed of a first carrying member supporting in an easily reversible manner on the one hand the chassis partaking of the first module and a back-up roll of the band against the printing head, and on the other hand the first support and the second support forming the second carrying member,
d) a rear closing shell which can be added in an easily reversible manner on the second support, said shell go providing a space for accommodating the battery between the rear face of the printer and a board carrying the electronic means of the second module and of the battery, said board forming a separation wall with mechanical and electrostatical insulation.

17. An application of a printer according to claim 1 to an office printer,
wherein the office printer comprises
a) a first module formed mainly of a printing mechanism comprising a chassis carrying a printing sheet metal, motorised means for driving the band, of a flexible connector for associating the printing mechanism with the remote electronic control means, and of a cutter for separating a portion of printed band,
b) a second module mainly composed of a second carrying member formed of a first support and of a second support, the first support carrying driving means for operating the printer by the user, the second support being arranged as a dummy cover and supporting in an easily reversible manner the electronic control means fitted with associating means with remote electronic printing control means, with a source of electric energy, and with the driving means, said electronic control means being complemented by any at least of management means specific of the source of electric energy, of integrated electronic control means and of means for storing information transmitted remotely by the remote printing control means, the source of electric energy being a remote source.
c) a third module mainly composed of a first carrying member supporting in an easily reversible manner on the one hand the chassis partaking of the first module and a back-up roll of the band against the printing head, and on the other hand the first support and the second support forming the second carrying member,
d) a rear closing shell which can be added in an easily reversible manner on the second support.

18. A printer according to claim 5, wherein the stand-alone source of electric energy comprises at least one battery carried by the rear face of the electronic board which moreover carries first elementary means of the second electronic control means and of the related associating means, said battery being housed in a space provided between the shell and the electronic board, the latter forming a separation wall for mechanic and electrostatic protection of the printing mechanisms and of the control means.

19. A printer according to claim 7, wherein the stand-alone source of electric energy comprises at least one battery carried by the rear face of the electronic board which moreover carries first elementary means of the second electronic control means and of the related associating means, said battery being housed in a space provided between the shell and the electronic board, the latter forming a separation wall for mechanic and electrostatic protection of the printing mechanisms and of the control means.

20. A printer according to claim 8, wherein the shell is fitted at its rear face with easily reversible nesting means with a base.
